(19) United States
(12) Patent Application Publication
(10) Pub. No.: US 2010/0064093 A1
(43) Pub. Date: Mar. 11, 2010

(54) SYSTEM, METHOD, AND COMPUTER PROGRAM PRODUCT FOR CONVERTING DATA IN A BINARY REPRESENTATION TO A NON-POWER OF TWO REPRESENTATION

(76) Inventor: Radoslav Danilak, Cupertino, CA (US)

Correspondence Address: Zilka-Kotab, PC, P.O. BOX 721120, SAN JOSE, CA, 95172-1120, US

(21) Appl. No.: 12/207,379

(22) Filed: Sep. 9, 2008

(51) Int. Cl. G06F 12/02; G06F 12/00

(52) U.S. Cl. 711/103; 711/E12.008

(57) ABSTRACT

A system, method, and computer program product are provided for converting data in a binary representation to a non-power of two representation. In operation, data in a binary representation is identified. Additionally, the data in the binary representation is converted to a non-power of two representation having a non-power of two number of voltage levels.

### FIELD OF THE INVENTION

The present invention relates to computer systems, and more particularly to reading and writing data from memory.

### BACKGROUND

Storage density is a measure of the quantity of information that may be stored on a given length of track, area of surface, or in a given volume of a storage device. Generally, a higher storage density is more desirable because it allows greater volumes of data to be stored in the same physical space. Density has a direct relationship to storage capacity of a given medium.

Density also generally has a direct effect on the performance within a particular storage device. The number of voltage levels is one of the key determining factors for determining storage density of flash devices. While increasing the number of voltage levels increases storage density, increasing the number of voltage levels also reduces reliability, the number of program/erase cycles, and/or retention time.

Currently, flash memory with eight voltage levels may be utilized efficiently. However, there is an upper limit on the number of voltage levels for commercially viable memory. Accordingly, there is often a number of voltage levels in between the number currently used in memory (e.g. 8) and the number of voltage levels that are not commercially viable (e.g. between eight and 16 voltage levels). There is thus a need for addressing these and/or other issues associated with the prior art.

### SUMMARY

A system, method, and computer program product are provided for converting data in a binary representation to a non-power of two representation. In operation, data in a binary representation is identified. Additionally, the data in the binary representation is converted to a non-power of two representation having a non-power of two number of voltage levels.

### BRIEF DESCRIPTION OF THE DRAWINGS

FIG. 1 shows a method for converting data in a binary representation to a non-power of two representation, in accordance with one embodiment.

FIG. 2 shows a method for converting data in a non-power of two representation to a binary representation, in accordance with one embodiment.

FIG. 3 shows a system including memory with non-power of two voltage levels, in accordance with one embodiment.

FIG. 4 shows a system including memory with non-power of two voltage levels, in accordance with another embodiment.

FIG. 5 illustrates an exemplary system in which the various architecture and/or functionality of the various previous embodiments may be implemented.

### DETAILED DESCRIPTION

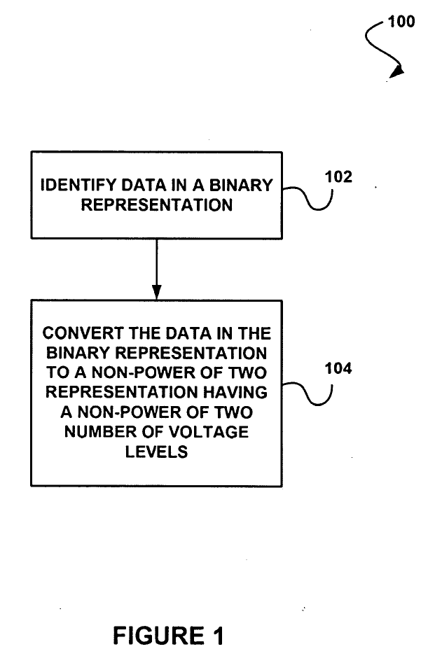

FIG. 1 shows a method 100 for converting data in a binary representation to a non-power of two representation, in accordance with one embodiment. As shown, data in a binary representation is identified. See operation 102. In the context of the present description, data refers to any data that may be represented in a binary form. In one embodiment, the binary data may include a binary representation of encoded non-power of two voltages.

Additionally, the data in the binary representation is converted to a non-power of two representation having a non-power of two number of voltage levels. See operation 104. In the context of the present description, a non-power of two representation refers to data that is represented by a number of voltage levels that is not a power of two.

In one embodiment, a host may communicate the data in the binary representation to a memory controller. In this case, the memory controller may convert the data in the binary representation into the binary representation having a non-power of two number of voltage levels using a closest larger power of two binary representation for the non-power of two number of voltage levels. The memory controller may then send the data in the non-power of two representation having a non-power of two number of voltage levels to the memory device.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

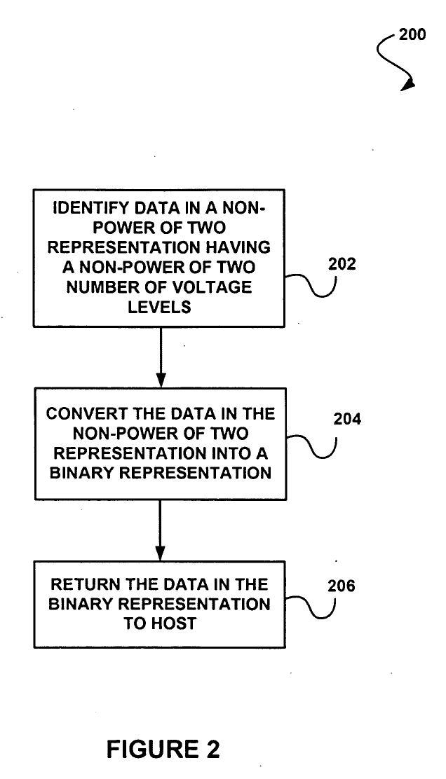

FIG. 2 shows a method 200 for converting data in a non-power of two representation to a binary representation, in accordance with one embodiment. As an option, the present method 200 may be implemented in the context of the functionality of FIG. 1. Of course, however, the method 200 may be carried out in any desired environment. It should also be noted that the aforementioned definitions may apply during the present description.

As shown, data in a non-power of two representation having a non-power of two number of voltage levels is identified. See operation 202. Additionally, the data in the non-power of two representation is converted into a binary representation. See operation 204. Still yet, the data in the binary representation is returned to a host after the conversion. See operation 206.

In one embodiment, a memory controller may communicate the binary data to a memory device (e.g. a flash memory device, etc.). The memory device may then convert binary data to the non-power of two number of voltage levels stored in memory device. The memory device may then convert the data in the non-power of two number of voltage levels stored in memory device to the binary representation. The binary representation may then be sent to the memory controller.

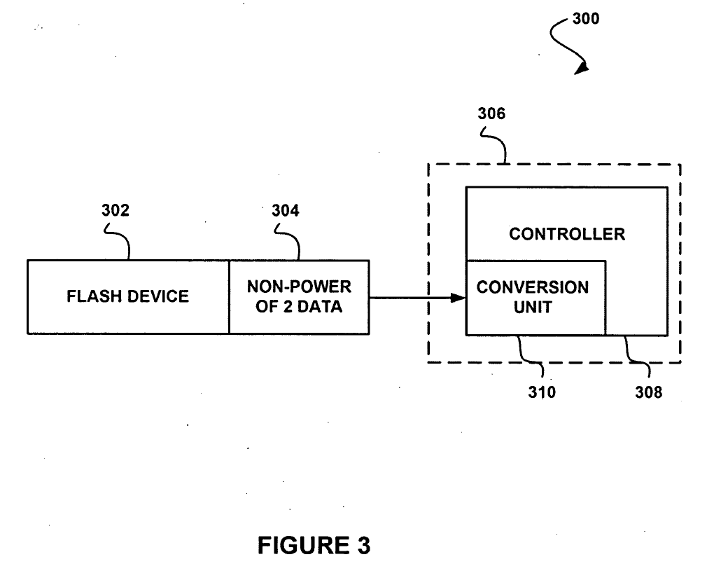

FIG. 3 shows a system 300 including memory 302 with non-power of two voltage levels, in accordance with one embodiment. As an option, the present system 300 may be implemented to carry out the methods 100 and 200 of FIGS. 1-2. Of course, however, the system 300 may be implemented in any desired environment. Again, the aforementioned definitions may apply during the present description.

As shown, the memory 302 may store data as non-power of two voltage levels data 304.

In one embodiment, the memory 302 may be included in a portable memory device. In the context of the present description, a portable memory device refers to any portable device capable of storing data. For example, in various embodiments, the portable memory device may include, but is not limited to, a removable hard disk drive, flash memory (e.g. a USB stick, etc.), removable storage disks (e.g. CDs, DVDs, etc.), and/or any other type of storage device.

In operation, data in a non-power of two representation having a non-power of two number of voltage levels may be identified. In one embodiment, the data in the non-power of two representation having a non-power of two number of voltage levels may be identified in association with a read operation. The data in the non-power of two representation having a non-power of two number of voltage levels may then be converted to a binary representation. Subsequently, the data in the binary representation may be read.

In one embodiment, the data in the non-power of two representation may be read by a host 306. In the context of the present description, a host refers to any device capable of hosting a storage device. For example, in various embodiments, the host may include, but is not limited to, a desktop computer, a laptop computer, a handheld computer, a personal digital assistant (PDA) device, a mobile phone, and/or any other host device that meets the above definition.

Furthermore, as an option, the conversion may be performed by the host 306. For example, in one embodiment, the host 306 may include a memory controller 308. In this case, the conversion may be performed by the memory controller 308. In some cases, the memory controller 308 may include a conversion unit 310. In these cases, the conversion unit 310 may perform the conversion. As another option, the conversion may be performed in memory.

Additionally, in the context of write operations, data in a binary representation may be identified. The data in the binary representation may then be converted back into a non-power of two representation having a non-power of two number of voltage levels. The data in the non-power of two representation having a non-power of two number of voltage levels may then be written to the memory 302 after the conversion. In one embodiment, the data in the non-power of two representation having a non-power of two number of voltage levels may be written by the host 306. Furthermore, as an option, the conversion of the data in the binary representation into a non-power of two representation may be performed by the host 306. For example, in one embodiment, the conversion may be performed by the memory controller 308. As an option, the conversion unit 310 may be used for converting the data. As another option, the conversion may be performed in memory.

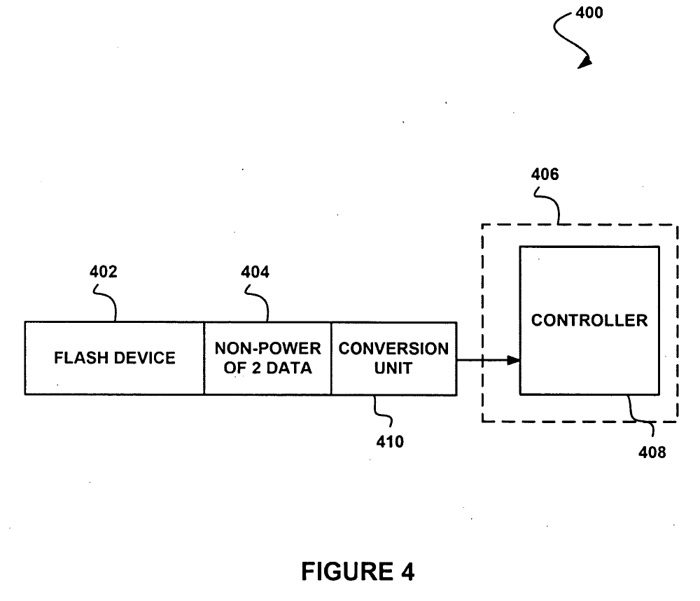

FIG. 4 shows a system 400 including memory 402 with non-power of two voltage levels, in accordance with another embodiment. As an option, the present system 400 may be implemented in the context of the architecture and/or functionality of FIGS. 1-3. Of course, however, the system 400 may be implemented in any desired environment. Once again, the aforementioned definitions may apply during the present description.

As shown, the memory 402 may include non-power of two data 404. The memory 402 may include any device capable of storage, such as volatile or non-volatile memory. In operation, data in a non-power of two representation may be identified. In one embodiment, the data in the non-power of two representation may be identified in association with a read operation.

The data in the non-power of two representation having a non-power of two number of voltage levels representation may then be converted to a binary representation. In this case, the conversion may be performed by the memory 402. In some cases, the memory 402 may include a conversion unit 410. In these cases, the conversion unit 410 may perform the conversion. Subsequently, the data in the binary representation may be returned to a host 406.

Additionally, in the context of write operations, data in a binary representation may be identified. The data in the binary representation may then be converted back into a non-power of two representation. The data in the non-power of two representation having a non-power of two number of voltage levels may then be written to the memory 402 after the conversion. In one embodiment, the data in the non-power of two representation may be written by the host 406.

As an option, the conversion of the data in the binary representation into a non-power of two representation may be performed by the host 406 using a memory controller 408. As another option, the conversion may be performed by the memory 402. In this case, the conversion unit 410 may be used for converting the data.

In this way, data may be coded as single number in a base determined by a number of voltage levels. For example, during encoding, multiplication may be performed during the conversion to binary data. In one embodiment, a conversion module may reside on the memory 402 (e.g. flash memory, etc.), on the memory controller 408, or anywhere within the host system 406 or memory device 402.

Further, for a number of voltage levels, division and/or modulo may be computed in a highly efficient manner. For example, a number of levels may be expressed as a multiplication of 2^{N}, 2^{N}−1, and 2^{N}+1. Additionally, other numbers of voltage levels may exhibit the ability to be implemented in a simplified way. For instance, for simplicity of a flash array, data may be transferred from bit-lines in the smallest 2^{N} number greater than or equal to a number of voltage levels supported by a flash device.

Table 1 shows an equation used for computing X mod (2**N+1), in accordance with one embodiment.

TABLE 1
Computing X mod (2**N + 1):

X mod (2**N+1) = ( (X[1*N−1:0*N] − X[2*N−1:1*N]) +
(X[3*N−1:2*N] − X[4*N−1:3*N]) + (X[5*N−1:4*N] −
X[6*N−1:5*N]) + (X[7*N−1:6*N] − X[8*N−1:7*N]) ... )
mod (2**N + 1)

Table 2 shows an equation used for computing X mod (2**N−1), in accordance with one embodiment.

TABLE 2
Computing X mod (2**N − 1)

X mod (2**N − 1) = X[1*N−1:0*N] + X[2*N−1:1*N] +
X[3*N−1:2*N] + X[4*N−1:3*N] + X[5*N−1:4*N] +
X[6*N−1:5*N] + X[7*N−1:6*N] + X[8*N−1:7*N] ... ) mod (2**N − 1)

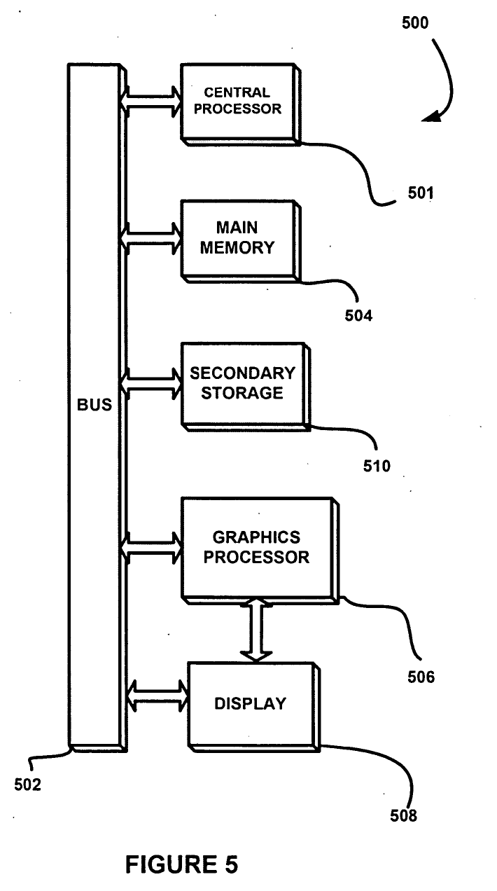

FIG. 5 illustrates an exemplary system 500 in which the various architecture and/or functionality of the various previous embodiments may be implemented. As shown, a system 500 is provided including at least one host processor 501 which is connected to a communication bus 502. The system 500 also includes a main memory 504. Control logic (software) and data are stored in the main memory 504 which may take the form of random access memory (RAM).

The system 500 also includes a graphics processor 506 and a display 508, i.e. a computer monitor. In one embodiment, the graphics processor 506 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 500 may also include a secondary storage 510. The secondary storage 510 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 504 and/or the secondary storage 510. Such computer programs, when executed, enable the system 500 to perform various functions. Memory 504, storage 510 and/or any other storage are possible examples of computer-readable media.

In one embodiment, the architecture and/or fuctionality of the various previous figures may be implemented in the context of the host processor 501, graphics processor 506, an integrated circuit (not shown) that is capable of at least a portion of the capabilities of both the host processor 501 and the graphics processor 506, a chipset (i.e. a group of integrated circuits designed to work and sold as a unit for performing related functions, etc.), and/or any other integrated circuit for that matter. In yet in another embodiment, the architecture and/or functionality of the various previous figures may be implemented in the context of the secondary storage 510.

Still yet, the architecture and/or functionality of the various previous figures may be implemented in the context of a general computer system, a circuit board system, a game console system dedicated for entertainment purposes, an application-specific system, and/or any other desired system. For example, the system 500 may take the form of a desktop computer, lap-top computer, and/or any other type of logic. Still yet, the system 500 may take the form of various other devices including, but not limited to, a personal digital assistant (PDA) device, a mobile phone device, a television, etc.

Further, while not shown, the system 500 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
identifying data in a binary representation; and
converting the data in the binary representation to a non-power of two representation having a non-power of two number of voltage levels.

2. The method as set forth in claim 1, wherein the conversion is performed by a memory controller.

3. The method as set forth in claim 1, wherein the conversion is performed in memory.

4. The method as set forth in claim 3, wherein the memory includes volatile memory.

5. The method as set forth in claim 3, wherein the memory includes non-volatile memory.

6. The method as set forth in claim 3, wherein the memory is included in a portable memory device.

7. The method as set forth in claim 1, wherein the conversion is performed by a host.

8. The method as set forth in claim 1, wherein the data in the non-power of two representation is identified in association with a read operation.

9. The method as set forth in claim 1, wherein the data in the non-power of two representation includes a binary representation of encoded non-power of two voltages.

10. The method as set forth in claim 9, wherein a flash memory device communicates the data in the binary representation to a memory controller.

11. The method as set forth in claim 10, wherein the memory controller converts the data in the binary representation into the non-power of two representation having a non-power of two number of voltage levels using a closest larger power of two binary representation for the non-power of two number of voltage levels.

12. The method as set forth in claim 11, wherein the non-power of two representation having a non-power of two number of voltage levels is sent to the flash memory device.

13. A method, comprising:
identifying data in a non-power of two representation having a non-power of two number of voltage levels; and
converting the data in the non-power of two representation into a binary representation.

14. The method as set forth in claim 13, wherein the conversion is performed by a memory controller.

15. The method as set forth in claim 13, wherein the conversion is performed in memory.

16. The method as set forth in claim 15, wherein the memory includes volatile memory.

17. The method as set forth in claim 15, wherein the memory includes non-volatile memory.

18. The method as set forth in claim 15, wherein the memory is included in a portable memory device.

19. The method as set forth in claim 13, wherein the conversion is performed by a host.

20. The method as set forth in claim 13, wherein the data in the non-power of two representation having a non-power of two number of voltage levels representation is written to memory after the conversion.

21. The method as set forth in claim 13, wherein the data in the non-power of two representation includes a binary representation of encoded non-power of two voltages.

22. The method as set forth in claim 21, wherein a memory controller communicates the data in the non-power of two representation having the non-power of two number of voltage levels encoded into a closest larger power of two binary power of two representation to a flash memory device.

23. The method as set forth in claim 22, wherein the flash memory device converts the data in the non-power of two representation having the non-power of two number of voltage levels encoded into a closest larger power of two binary power of two representation to the non-power of two representation having a non-power of two number of voltage levels representation.

24. The method as set forth in claim 23, the non-power of two representation having a non-power of two number of voltage levels encoded into closest larger power of two binary power of two representation is sent to the memory controller.

25. A system, comprising:
a controller for identifying data in a binary representation and converting the data in the binary representation to a non-power of two representation having a non-power of two number of voltage levels.

26. A computer program product embodied on a computer readable medium, comprising:
computer code for identifying data in a binary representation; and
computer code for converting the data in the binary representation to a non-power of two representation having a non-power of two number of voltage levels.
